(19) United States
(12) Patent Application Publication
(10) Pub. No.: US 2008/0233369 A1
(43) Pub. Date: Sep. 25, 2008

(54) RECORDING SUPPORT

(75) Inventors: Hendrikus Gijsbertus Johannes VERHOEVEN, Eindhoven (NL); Johannes Jacobus Gerardus Van Velzen, Tilburg (NL)

Correspondence Address: BANNER & WITCOFF, LTD., 28 STATE STREET, 28th FLOOR, BOSTON, MA, 02109-9601, US

(73) Assignee: FUJIFILM Manufacturing Europe B.V., Tilburg (NL)

(21) Appl. No.: 12/051,147

(22) Filed: Mar. 19, 2008

Related U.S. Application Data
(63) Continuation of application No. PCT/NL2006/000483, filed on Sep. 28, 2006.

(30) Foreign Application Priority Data
Sep. 28, 2005 (EP) 05077219.3

(51) Int. Cl. D21H 19/36; B32B 7/00; B29C 47/06

(52) U.S. Cl. 428/207; 162/135; 264/173.18

(57) ABSTRACT

According to the invention there is provided a pigment coated paper base that comprises a paper base, which paper base comprises one or more wet strength agents, and a pigment coating on at least the topside of said paper base, which pigment coating comprises one or more insolubilizers. This pigment coated paper base may be provided with a polymer resin coating at the backside and is suitable for use in a wide range of inkjet printing application.

Further this invention is directed to a pigment coated paper base provided with a polymer resin coating on the top-side and optionally on the backside that is suitable for use as support in a wide range of recording media.

### RELATED APPLICATIONS

This application is a continuation of PCT application no. PCT/NL2006/000483, designating the United States and filed Sep. 28, 2006; which claims the benefit of the filing date of European application no. EP 05077219.3, filed Sep. 28, 2005; each of which is hereby incorporated herein by reference in its entirety for all purposes.

### FIELD

The present invention relates to a support material for use in recording applications. In particular the support material of the present invention comprises a pigment coated paper base provided with a resin coating on its top-side (viz. the side to be printed on) and optionally also on its back-side. Further this invention is directed to a printing paper comprising a pigment coated paper base, optionally provided with a resin coating on the back-side.

### BACKGROUND

In general a support material used in recording media comprises a base on which at least one resin layer is applied. On top of this resin layer a receiving medium may be applied, depending on the recording method used, e.g. an emulsion layer for (conventional) photography applications or an ink receiving layer for inkjet applications or a layer for thermal or electro-photographical paper application.

Although the supports of these recording media may require different compositions, it would be very efficient for the paper base manufacturer to produce one single paper base as support, which can then be used in different recording processes. Thus the paper base may be produced in one single manufacturing step without the need to frequently start or stop the manufacturing process or to adjust the recipes in the manufacturing process. A prerequisite would be that this support should have a high quality with respect to physical properties and that the raw material price should be low. One of the important properties is the smoothness of the support. Although a rather smooth paper base surface can be obtained by calendaring or super-calendaring a non pigment coated paper base, the best way to obtain a smooth and glossy surface is to use a pigment coating at least on the top-side surface of the paper base and optionally calendaring the coated material afterwards. In case waterproof paper is required a polymer resin can be applied on both top-side and back-side of the pigmented coated paper base which is usually a titanium oxide filled polyethylene, polypropylene, polymethyl-methacrylate resin and the like. The application of the polymer resin layer is generally done via a melt (co)-extrusion process.

An important aspect of a support in photographic and printing application is that the support needs to be resistant against many conditions related to the existing processing systems. Properties related to the resistance against edge penetration of the developing liquid or water and/or properties with respect to transportability such as scratch resistance in the development process or printing process need to be considered well.

Recently we observed problems with the resistance in automatic image processing devices, such as the well-known Minilab.

In particular the convey-ability of resin-coated supports for photographic application comprising a pigment coated paper base was insufficient, more in particular we observed severe damages at the edges after processing these products through certain types of mini-laboratories.

In the prior art there are several examples which describe the use of a pigment coated paper base as a support for recording media.

EP-A-1 126 081 is a pigment coated paper with a specified pigment particle size for improving the adhesion and surface properties.
US-A-2005/0032644 and US-A-2005/0031805 are describing pigment coated paper bases with specific binders and pigments for improved smoothness and stability. However all these documents are silent towards the phenomenon of edge damage.

### SUMMARY

It is an object of the present invention, to provide a support that is suitable for use as support for a wide range of recording media.

It is a further object of this invention to provide a support for recording media with a high smoothness and resulting in a high gloss for recording applications.

It is a further object of this invention to provide a support for recording media with acceptable edge damage properties after processing through processing equipment.

It is a further object of this invention to provide a support for recording media with acceptable edge penetration properties after processing through processing equipment.

It is another object of the present invention to provide a multi-purpose pigment coated paper base that is suitable for use in a wide range of printing applications.

It is another object of the present invention to provide a pigment coated paper base that has good run-ability properties during processing.

It has now been found that these objects are at least in part achieved by providing a pigment coated paper base comprising a paper base and a pigment coating on at least the top of said paper base, wherein said paper base comprises one or more wet strength agents and in which said pigment coating comprises an insolubilizer. In this way it is possible to achieve at least one of the following:
avoiding edge damage during processing in automated photo printing processes;
improving scratch resistance when used as inkjet paper; and decrease dust deposit on the prints after printing.

### DETAILED DESCRIPTION

According to the present invention there is provided a pigment coated paper base that comprises a paper base, which paper base comprises one or more wet strength agents, and a pigment coating on at least the topside of said paper base, which pigment coating comprises one or more insolubilizers. Optionally, a pigment coating, which may be of the same or a different composition as the pigment coating on the topside is also present on the backside of the paper base. Thus specific embodiments of the invention include: P-B and P-B-P, wherein, going from top to bottom, “P” refers to a pigment coating layer and “B” refers to the paper base.

The pigment coated paper base according to the present invention can be used per se as a printing paper. The pigment coated paper according to the present invention may be provided with one or more polymer resin coatings on the backside and can be used too as a printing paper. Thus further specific embodiments of the invention include: P-B-R and P-B-P-R, wherein, going from top to bottom, “P” and “B” have the same meaning as indicated above and “R” refers to a resin layer.

Further, the pigment coated paper base can be coated on its topside (viz. on top of said pigment coating layer, i.e. on top of said pigment coating layer) with a polymer resin layer. A topside resin polymer coating can be applied on a pigment coated paper base with or without a backside resin polymer coating. The top and backside resin polymers layer may be of the same or a different polymer. Pigment coated paper base that is provided with one or more polymer resin layers on the topside and optionally the backside can be used as a support for other recording applications, in particular emulsion based photographic recording applications. Thus further specific embodiments of the present invention include: R-P-B, R-P-B-P, R-P-B-R, R-P-B-P-R, wherein, going from top to bottom, “P”, “B” and “R” have the same meaning as indicated above.

In our search for high quality, multipurpose supports for recording media we came across the problem that a support without a pigment coated layer on top of the paper base performs differently from a support that has a pigment coated layer on top of the paper pulp. This is in particular the case in automated photo processing units, such as the well-known so-called minilabs in the photographic industry, where prints are pre-cut before they are developed and processed. It was found that unacceptable edge damages can become visible in the pigment coating layer of the pigment coated paper base and that this problem does not occur in paper bases without this pigment coating layer. Without wishing to be bound by theory, one explanation for this so-called front edge damage can be, that the pigment coating layer is weakened by processing liquid penetration at the cut top-edge and subsequently damaged by jamming on the transporter guides at the edges.

We have found, that by means of a resin-coated support comprising a pigment coated paper base, which comprises a wet strength agent in the base paper in combination with the application of a pigment coating with an insolubilizer, surprising advantages can be achieved.

For photographic application the combined usage of wet strength agents and insolubilizer results in an edge damage improved support during processing in minilabs.

For printing application the combined usage of wet strength agents and insolubilizer results in much better run-ability and ease of transport through the printing machines. We observed less scratches and less dust deposit on the prints after printing when using the pigmented coated paper bases in accordance with this invention. Without wishing to be bound by theory one explanation for this phenomenon is that the combined usage of wet strength agent in the paper base and use of insolubilizers in the pigment coating will result in less swelling due to ink absorption from the pigment layer into the paper and therefore to less jamming on feeding-parts in the printers.

In accordance with the present invention the wet strength agent can be incorporated during any stage of the base paper making process. Wet strength agents are additives that are well-known in the paper making industry. Wet strength agents, give the paper an increased strength in wet state and in accordance with the present invention these wet strength agents may be selected in general from a broad class of components, including thermosetting resins, aminoplast resins, metal based compounds, and combinations thereof. More in particular, the wet strength agents may for instance be selected from epoxidized polyamide resins such as poly(amido-amine)-epichlorohydrin (PAE) resins, sometimes referred to as polyamide-polyamine-epichlorohydrin (PPE) resins, or from polyalkylene polyamine-epichlorohydrin (PAPAE) resins, or from amin-polymer-epichlorohydrin (APE) resins, or combinations thereof. Other wet strength agents which may be selected are zirconium based compounds (like ammonium zirconium carbonate, potassium zirconium carbonate, zirconium acetylacetonate, zirconium acetate, zirconium carbonate, zirconium sulphate, zirconium phosphate, zirconium sodium phosphate and sodium zirconium tartrate), melamine-formaldehyde resins, urea-formaldehyde resins, dialdehyde starch (DAS), glyoxal and glyoxalated polyacrylamide (PAM) and polyethylenimine (PEI) resins.

These wet strength agents can be applied in the range of 0.1 to 2.0 wt. % versus the dry pulp weight of the paper base and can be used alone or in mixtures of two or more thereof. In a preferred embodiment of this invention the wet strength agent is chosen from the group of PAE-resins. The synthesis of these PAE resins generally involves the formation of a pre-polymer containing secondary or tertiary amine functionality, followed by reaction of the pre-polymer in aqueous solution with epichlorohydrin. The reaction conditions and variants to obtain PAE resins are described below and also have been described in U.S. Pat. No. 2,926,116 and U.S. Pat. No. 2,926,154.

The pre-polymer synthesis is a poly-condensation reaction between dicarboxylic acids and a polyamine, usually carried out at moderate temperatures (150-170° C.) in absence of solvent. Its reaction may be stopped by the addition of water and cooling. A wide range of materials can be used as components. Secondary amine functionality can be introduced by for instance the use of diethylelene triamine. As dicarboxylic acid there is a preference to use aliphatic dicarboxylic acids with a chain length up to 8 carbon atoms as practical limit for solubility reasons. A preferred dicarboxylic acid is adipic acid.

Besides the use of wet strength agents in the base paper making process sizing agents may be incorporated during any stage of the base making process.

Non-limiting examples of these sizing agents are epoxidized fatty acid amides (EFA) and alkyl ketene dimers (AKD). These sizing agents may be used alone or in mixtures of two or more thereof.

Specific examples of EFA such as condensation products of fatty acids and polyamines are as disclosed, e.g., in JP-38-20601, JP-39-4507, U.S. Pat. No. 3,692,092, and the reaction products of alkenyl succinic acids and polyamines as disclosed in JP-51-1705. Of the fatty acids as cited above, those preferred in the present invention are aliphatic mono- and polycarboxylic acids containing 8 to 30, especially 12 to 25, carbon atoms. Specific examples of such aliphatic carboxylic acids include stearic acid, oleic acid, lauric acid, palmitic acid, arachic acid, behenic acid, tall oil fatty acid, alkylsuccinic acid, alkenyl succinic acid, and so on. In particular, behenic acid is preferred.

As for the polyamines, polyalkylenepolyamines, especially those having two or three amino groups, are preferred. Specific examples of such polyamines include diethylenetriamine, triethylenetetramine, tetraethylenepentamine, pentaethylenehexamine, dipropylenetriamine, tripropylenetetramine, aminoethylethanolamine, and so on. In order to render the reaction products of aliphatic carboxylic acids with polyamines soluble or dispersible in water, it is preferred to convert them into salts by making them react with an inorganic or organic acid or to modify them using an alkyl halide, benzyl chloride, ethylene chlorohydrin, epichlorohydrin, ethylene oxide or the like so as to have the form of quaternary salt. In particular, it is favored to convert them into quaternary salt via the reaction with epichlorohydrin, because the resulting salts can provide a great sizing effect. The epoxidized higher fatty acid amides are added in a proper amount, provided that the proportion thereof to the bone dry pulp is not greater than 2.0% by weight, preferably within the range of 0.1 to 2.0% by weight and more preferably from 0.1 to 1.0% by weight.

As examples for alkyl ketene dimers (AKD) in practice alkyl ketene dimers of differing lengths of alkyl chains can be used (“mixed” alkyl ketene dimers). The alkyl residues therein may contain between 12 and 18 carbon atoms as is illustrated e.g. in Research Disclosure, November 1978, report 17516. Alkyl ketene dimers of between 16 and 18 carbon atoms alkyl residues are commonly used. Also the alkyl ketene dimers derived from higher fatty acids containing 8 to 30 carbon atoms are very suitable and also those described in U.S. Pat. No. 4,820,582. In particular, the alkyl ketene dimer derived from behenic acid is used to advantage. A suitable proportion of the alkyl ketene dimer is in the range of 0.05 to 2.0% by weight, preferably from 0.1 to 1.0% by weight, and more preferably from 0.2 to 0.8% by weight based on bone dry pulp. Preferably the amount of AKD is kept as low as possible. It is found that AKD tends to migrate to the paper surface and by this causing stain formation in the manufacturing process. However when the AKD amount is too low, the problem of edge penetration is visible which are colored edges found in the silver halide photographic process due to entering of the developing liquid into the cellulose fibers through the edges after processing. Therefore in a preferred embodiment of this invention the amount of AKD is kept between 0.3 and 0.7% by weight based on bone dry pulp.

Furthermore the preferred EFA/AKD ratio is from 10/90 to 60/40 when both EFA and AKD are used because this helps to get an acceptable edge penetration property.

During the paper manufacturing of the present invention apart from the wet strength and sizing agents other materials conventionally used in paper base manufacturing are used. Generally the paper is based on natural wood pulp and if desired a filler such as talc, calcium carbonate, TiO₂, BaSO₄ and the like is used. Generally the paper base also may comprise coloring agents such as dyes, optical brighteners and the like. Further the paper substrate may contain a dry strength agent like polyacrylamide or starch.

Further additives in the paper substrate can be fixing agents, such as aluminum sulphate, starch, cationic polymers and the like. In order to get an especially good paper base usually short fibers are used in the natural pulp.

The raw paper substrate made as described above may be impregnated or coated with a solution containing various water-soluble additives by means of a size press, a tub size, a gate roll coater or the like. Specific examples of water-soluble additives include high molecular compounds such as starch, polyvinyl alcohol, latex, carboxy-modified polyvinyl alcohol, carboxymethyl cellulose, hydroxyethyl cellulose, sodium alginate, cellulose sulphate, gelatin, casein, etc., and metal salts such as calcium chloride, sodium chloride, sodium sulphate, etc.

To the solution containing water-soluble additives as cited above, there may be further added a hygroscopic compound such as glycerol, polyethylene glycol, or the like; a coloring or brightening material such as dyes; an optical whitening agent or the like; and/or a pH controlling agent, such as sodium hydroxide, aqueous ammonia, hydrochloric acid, sulphuric acid, sodium carbonate, etc. In addition, pigments and also the wet strength and sizing agents which were discussed above in the detailed description may be added to the foregoing solution, if desirable.

This impregnating of the raw paper substrate is called surface sizing as is well known to those skilled in the art.

The raw paper base is not particularly restricted in its species and thickness. However, it is generally desired that the base has a weight ranging from 50 to 300 g/m².

The paper base is typically prepared from the above components in a conventional way using known machinery. After the cellulose fibers in their formulation are applied to a dewatering web they are dried to form a paper sheet which is wound on big rolls.

To the paper base described above a pigmented coating layer is applied to obtain the pigment coated paper base as support. This pigmented coating comprises or is based on a liquid, in particular water, optionally in combination with other liquids, one or more pigments, one or more binders, one or more insolubilizers and other components suitable for preparing a stable pigment dispersion suitable for application onto a paper base. The pigment coating is applied to the paper base by coating a solution or dispersion comprising the liquid and the pigment. After the coating step, the liquid is allowed to evaporate so that the coating is formed.

Insolubilizers (or so-called cross-link agents) in the pigment coating for use in the present invention may in general be selected from the broad class of components which render the pigment coating water resistant, and include thermosetting resins, aminoplast resins, metal based compounds, and combinations thereof. More in particular, the insolubilizer may for instance be selected from epoxidized polyamide resins, melamine-formaldehyde resins, urea-formaldehyde resins, dialdehyde starch (DAS), glyoxal and glyoxalated polyacrylamide (PAM), polyethylenimine (PEI), polyglycidylether and azaridine resins and combinations thereof. Preferably, the insolubilizer is selected from polyglycidylether such as pentaerythritol polyglycidylether or zirconium based compounds, such as ammonium zirconium carbonate, potassium zirconium carbonate, zirconium acetylacetonate, zirconium acetate, zirconium carbonate, zirconium sulphate, zirconium phosphate, zirconium sodium phosphate, sodium zirconium tartrate and combinations thereof. These insolubilizers are applied in an effective amount, typically in the range of 0.1 to 30 wt. % versus the dry binder and can be used alone or in mixtures of two or more thereof. Especially in the case of the group of polyglycidylethers a very small amount of insolubilizer is enough to become effective. The minimum amount may very around 0.1 wt. % and is preferably 0.3 wt. % or more in case a pentaerythritol polyglycidylether is used. In the case a zirconium based material is used the minimum amount to become effective may vary around 3.0 wt %, preferably around 5 up to 10% when using ammonium zirconium carbonate. In general higher amounts of solubilizer, e.g. in the range of 20 wt. to 30 wt. % will generally not result in better results of edge damage and are thus generally not desired for economical reasons.

The pigment can suitably be selected from kaolin, clay, titanium dioxide, calcium sulphate, barium sulphate, satin white, synthetic silica, China clay, magnesium carbonate, alumina, talc, illite, delaminated clay, ground calcium carbonate, precipitated calcium carbonate, zinc oxide, silicic acid, silicate, colloidal silica other metal oxides or salts and the like, as well as organic pigments such as plastic pigment. These pigments can be used alone or in combination.

The binder can be selected from polyvinyl alcohol, starch—including oxidized starch, esterified starch, enzymatically denatured starch, cationized starch, and the like—casein, soybean protein, dextrin, cellulose derivatives including carboxy-methyl cellulose, hydroxyethyl cellulose and the like, a styrene-acrylic latex, an isobutylene-maleic anhydride latex, an acrylic latex, a vinyl acetate latex, a vinylidene chloride latex, a polyester latex, a styrene-butadiene latex, methyl methacrylate butadiene latex, polyacrylate latex, an acrylnitrile-butadiene latex and the like. These binders can be used alone or as a mixture of two or more thereof.

Especially styrene-acrylic latex is favored in accordance with the present invention because it exhibits color stability to various light intensity exposures in time.

Although a binder to pigment ratio of higher than 40/100 in an embodiment of the pigment coating layer without the incorporation of an insolubilizer will result in an improved edge damage property, for economical reasons and for reasons of colour stability it is preferred to use an amount of binder that is as low as possible. Therefore in a specific embodiment of this invention the binder to pigment ratio is ranging from 10/100 to 40/100.

The pigment coating compositions will generally also contain a dispersing agent for the inorganic pigment, preferably in an amount of from 0.02% to 1% by weight, based on the weight of the pigment. If desired, an anti-foaming agent, a pH adjuster and one or more other conventional additives may also be added to the coating solution for the pigment coatings, insofar as the effects of the present invention are not marred by the addition thereof.

It is preferred that the pigment is hydrophilic. An aqueous pigmented coating dispersion can be applied in various ways, by which a hydrophilic coating may be obtained in accordance with the present invention of the support.

One way is to apply the pigment coating during the paper making process after the dewatering step. This coating can be applied in a way that is familiar to those skilled in the art. After applying the coating, the paper is dried further before winding it in the paper machine.

The pigmented dispersion can also be applied after the paper has been wound on rolls, by unwinding the roll and apply the pigmented coating, drying and winding again. The aqueous pigmented coating is preferably applied at temperatures below 100° C., more preferably at a temperature of 20-80° C. Also a combination of both methods can be used.

The application of the coating can be done using conventional methods like double-roll size-press coater or gate-roll coater, blade-metering size-press coater or rod-metering size-press coater, sym-sizer or other film-transfer roll coater, flooded-nip/blade coater, jet-fountain/blade coater and short-dowel time-application coater, a rod-metering coater using grooved rods or plain rods instead of blades, curtain coater, die coater or any other known coater.

The total amount of pigment or pigment mixture to be used is not particularly limited. Good results are obtained with pigmented coating amounts of from 0.5 to 40 g/m², preferably the amount is between 1 and 30 g/m². The particle size of the pigment is in principle not restricted, but smaller particle size distributions can have benefits in providing adhesion or gloss. Pigments in which at least 70% of the particles have a size smaller than 1 μm and in which at least 40% have a size between 0.35 and 0.80 μm may be advantageously used.

Calendering of the paper is very beneficial to obtain a smooth and glossy surface. Calendering can be done at various stages during the manufacturing of the pigment coated paper base. It can be done for example before the application of the pigment coating or after the application of the pigmented coating. In all cases is it possible to obtain a pigment coated paper base with a surface roughness R_{A} of below 1.0. The surface roughness parameter is commonly used and known to those skilled in the art. Surface roughness parameter is suitably measured using UBM equipment with the following settings:

(1) Point density 500 P/mm

(2) Area 5.6×4.0 mm

(3) Cut-off wavelength 0.80 mm

(4) Speed 0.5 mm/sec.

according to DIN 4776; software package version 1.62.

Preferably, the surface roughness parameter R_{A} is below 1.0. The more preferred surface roughness is less than 0.8 μm. If one wants to have a very smooth and high gloss pigment coated paper base material a surface roughness below 0.5 μm may be advantageous. This low surface roughness can be obtained by any calendaring available like machine calendering, soft calendering and super calendering. In the calendering step during paper making, the paper is pressed between rollers. By this the space between the fibers gets less, by which a smoother surface results. A disadvantage is that the thickness and stiffness of the paper is negatively influenced if the pressure of the calender rolls is increased too much. When using low grade paper base the thickness and stiffness qualities may become below an acceptable level using super calendering. However it is possible to obtain these values for the surface roughness, namely in case a good quality paper base with sufficient bulk paper density is pigment coated according to the present invention. With these type of papers the thickness and stiffness quality remain within acceptable levels even with high level calendering, resulting in very low surface roughness values R_{A} of 0.5 μm or less. Using the technique of the present invention it is possible to use a variety of paper qualities and upgrade these by the method described above.

The pigment coated paper base as it is described above is very suitable for use as a printing paper in printing applications like Giclée printing, colour copying, screen printing, xerography, gravure, dye-sublimation, flexography or inkjet. Compared to the prior art, the paper of the present invention shows improved scratch resistance and less dust formation in inkjet applications. In certain printing applications it may be advantageous to coat the pigment coated paper base on the back-side with a polymer resin.

For photographic applications the above described pigmented paper base is usually coated on the top-side and the back-side with a polymer resin.

The application of the polymer resin on top and/or back-side is conventionally done using a melt extrusion coating (MEC) technique. Optionally in a preferred embodiment a co-extrusion technique is used in which polymer layers of various compositions can be coated simultaneously on the pigment coated paper base. This process is conventionally performed at line speeds over 200 m/min and preferably over 300 m/min. At such high line speeds crater defects, pinholes easily occur in the top-side resin layer, which results in a matte-like appearance.

In EP-A-0 952 483 it has been described, that a surface roughness R_{A} of a pigment coated paper base below 1 μm is required to prevent the occurrence of crater defects during the melt extrusion coating. As expected the pigmented coated paper base according to the present invention gives almost no crater defects upon extrusion coating, while a very high smoothness and gloss is obtained. The MEC is performed by applying thin layers of polymers simultaneously at high temperatures from 280 to 340° C. using high line speeds from over 200 m/min and preferably over 300 m/min. The layers at the topside can be applied by stepwise extrusion of single polymer layers or preferably in a co-extrusion MEC system. If necessary, the top surface, and also the back-surface of the pigment coated paper base is subjected to an activation treatment before and/or after the MEC. The treatment may comprise a corona treatment and/or a flame treatment and/or ozone treatment and/or plasma treatment or combinations of these treatments.

The polymer resin can be selected from high-density polyethylene, medium density polyethylene and low-density polyethylene, polypropylene, polybutene, polystyrene, polyvinyl chloride, polyvinylidene chloride, polycarbonate, polyethylene terephthalate, polyamide and polyacrylate resins and the like, co-polymers of two or more olefins such as ethylene-propylene co-polymer, ethylene butylene co-polymer, ethylene octene copolymer and mixtures thereof can be applied. These polymers have no particular limitations on molecular weight, provided that the resin coating formed by an extrusion coating method can retain therein a white pigment and a colored pigment or a brightening agent. In general, however, resins having their molecular weight in the range of 20 000 to 200 000 are used. Particular preferable polyolefins are high-density polyethylene, medium density polyethylene and low-density polyethylene and mixtures thereof. In case the resin layer is of the multi-layer type, resins in each layer may differ from each other in chemical structure and/or in physical properties such as melt indexes.

The polymer resin layer will generally contain additives such as white pigments (metal-oxide), dyes, colored pigments, adhesion promoters, optical brighteners, stabilizing agent such as, bisphenol, thiobisphenol, amines, benzophenone, salicylates, benzotriazole and organometallic compounds and the like. The polymer resin layer on the top-side will preferably contain a white pigment and a colored pigment or dyes.

The pigments for the polymer resin layer can be selected from the group consisting of kaolin, clay, titanium dioxide, calcium sulphate, barium sulphate, satin white, synthetic silica, China clay, magnesium carbonate, alumina, talc, illite, delaminated clay, ground calcium carbonate, precipitated calcium carbonate, zinc oxide, silicic acid, silicate, colloidal silica other metal oxides or salts and the like and combinations thereof.

The polyolefin resin coating do not have any particular restriction as to the coated amount/m² or to thickness. A polymer resin weight of up to 60 g/m² (for professional paper grade) can be used, but preferred resin ranges depend on the usage for specific market products (like professional, consumer markets). Conventionally the resin weight for a consumer product varies between 30 and 35 g/m², whereas there are applications, such as for consumer products, where an amount of lower than 30, or even 15 to 25 g/m² may be used for the top-side resin. Because of the use of the pigment coated paper base during MEC the amount of applied polymer can be reduced when compared to conventional non-pigment-coated paper base and still obtain a smoother and glossier product. In order to obtain a good behavior with respect to curling the back-side polymer resin layer may be adjusted accordingly and may comprise resin amount from 5-60 g/m², preferably 10-50 g/m².

The thickness of the polymer resin layer is mainly determined by the amount of polymer resin applied and may generally vary in the range of 5 to 60 μm.

The total thickness of the pigment coated paper base on which the polymer resin is applied may vary e.g. between 60 and 360 μm.

It is also possible to omit the back-side polymer resin coating and to use other means for curl compensation by applying for example a gelatin coating. Although a pigment coated paper base provided with a polymer resin on the top-side only is very suitably as support for many recording applications where a high quality print is required, it is evident, that this paper is not or less suitable in a photographic process where developer solution can freely penetrate through the back-side, staining the obtained image.

The polymer resin coat can be applied on the pigment coated paper base using known means, e.g. ordinary extruders and laminators for polyolefins.

The resin-coated support is very suitable as a support for various kinds of recording applications, such as a support for Giclée printing, colour copying, xerography, screen printing, gravure, dye-sublimation, flexography, inkjet and photography. When provided with a silver halide emulsion, it is very suitable to be used in photographic applications. When provided with a swellable layer mainly composed of gelatin and other water soluble polymers, it is very suitable to be used in inkjet or dye sublimation application. When it is provided with a micro porous layer it is very suitable for inkjet and dye sublimation applications and so on.

The present invention is furthermore directed to the manufacturing of a pigment coated paper base comprising a paper base with at least one wet strength agent, applying an aqueous pigmented coating on the top-side of said paper base and optionally applying a resin-coating by MEC on the back-side of the pigment coated paper base to give a paper for printing application.

Furthermore, the invention is directed to a method for producing a topside or a topside and backside resin-coated support using MEC comprising a pigment coated paper base with at least one wet strength agent, applying an aqueous pigmented coating on said topside of said paper base drying this and optionally calendaring it to give a support for recording applications.

Furthermore, the invention is directed to a photographic paper comprising said resin-coated support and a photographic emulsion applied on said support and to an inkjet paper comprising said resin-coated support and an ink receiving layer applied to said support and to an inkjet paper comprising said pigment coated paper base with optionally a resin-coating at the back-side of said pigment coated paper base.

Furthermore the invention is directed to the use of said photographic paper and inkjet paper in photographic applications and inkjet applications, respectively.

The invention is now further elucidated on the basis of the following examples.

### EXAMPLES

### Base Paper Preparation

### Comparative Example 29

A high quality paper substrate, comprising 100% hardwood kraft bleached pulp was used. In stock preparation, after refining, the following chemicals were added in wet end. An OB was added, a starch as dry strength agent, AKD as sizing agent and PAE as wet strength agent were added. After drying, a surface-size solution comprising starch and NaCl was applied in size press, then it was dried again. Basis weight of the paper thus obtained was 150 g/m². Subsequently the paper substrate was calendered until a bulk density ranging between 0.95-1.00 g/cm³ and an average surface roughness R_{A} of 1.2 μm was achieved.

### Paper Base Preparation

### Inventive Examples 1-17/Comparative Examples 19-27

### The same procedure as described above was followed for the paper base making for inventive Examples 1-17 and comparative Examples 19-27 except that AKD or AKD/EFA-mixtures as sizing agents and PAE as wet strength agent were used in various amounts (in wt % versus dry bone pulp) in the wet end chemistry.

### Paper Base Preparation

### Inventive Example 18/Comparative Example 28

For inventive Example 14 and comparative Example 24 instead of in wet end, the wet strength chemical PAE was applied in surface size process on both top- and back-side of the paper.

### Pigment Coated Paper Base Preparation

### Inventive Samples 1-18/Comparative Examples 19-28

A pigment coating was applied on the wire-side of the paper for inventive Examples 1-18 and comparative Examples 19-28, with a coating weight of 20 g/m², using calcium carbonate (85% 1-2 μm average diameter and 15 wt. % of CaCO₃<1.0 μm average diameter) as pigment. On 100 parts by weight of CaCO₃, various weight in parts of styrene acrylate latex or polyvinyl alcohol (PVOH) and/or natural starch were used as binder. Further on 100 parts by weight of CaCO₃ various weights in parts of insolubilizer 1

and 2 (respectively ammonium zirconium carbonate and penta erythritol polyglycidylether) were used in the pigment coating. After drying and calendaring an average surface roughness R_{A} of 0.8 μm was achieved.

### Comparative Example 29 is an Example which has No Pigment Coated Layer

The EFA used was a condensation product of behenic acid diethylenetriamine/triethylenetetramine and epichlorohydrin.

The AKD used was an AKD derived form behenic acid.

The PEA used was Kymene™ 557H (Hercules Incorporated).

Experiment 1

Scratch evaluation was done visually using the pigment coated paper base Examples 1-28 and the non-pigmented coated Example 29 after ink-jet printing them with a standard image comprising black, cyan, magenta and yellow bars. The image was printed at room conditions (23° C. and 48% Relative Humidity) and the prints were kept at this conditions for at least 1 hour to dry. A HP® photosmart 7960 printing device was used to print the images with the following settings:

1) Print quality best

2) other parameters were according factory setting

Table 1 gives the results of the Examples 1-29 on scratch evaluation. The scratch damage is scored as follows:

xxxx: many scratches and not acceptable

xxx: moderate scratch amount and just acceptable

xx: good appearance; small scratches

x: very good appearance, almost no scratches visible by eye

Although comparative Example 29, a non-pigment coated paper base, had no scratches the results with respect to smoothness and feathering were not acceptable.

Experiment 2

### Examples 1-18 (in accordance with the invention) and comparative

Examples 19-28 as prepared in Experiment 1 were melt co-extrusion coated at the topside of the pigmented coating and the non-pigmented example 29 was melt co-extrusion coated on the paper with following structure:

1) Outermost layer (image side), 1 g/m², containing a LDPE/LLDPE with ratio of 50/50,

2) second layer, 12.5 g/m², containing LDPE, 25% anatase TiO₂ pigment, ultramarine blue and ultramarine violet, quinacridone and bis-benzoxale substituted stilbene type optical brightener, and

3) the third layer, nearest to the pigmented coated paper, 16.5 g/m², containing LDPE, 5% anatase TiO₂ pigment, ultramarine blue and ultramarine violet and quinacridone. A line speed of 350 m/min was used to give the Examples 1-29.

The melt temperature is 320° C. with a nip roll pressure of 4.0 N/m² at a glossy cooling roll. The back-side of the paper substrate is extrusion coated with a LDPE/HDPE ratio of 50/50 with an amount of 20 g/m². Before the polyethylene layers are extruded, the paper surface is first activated by Corona treatment in order to improve the adhesion between the paper surface and the polyethylene melt.

Examples 1-29 were coated with a normal photographic emulsions and processed on a minilab (Frontier™ 350, Fuji photo film) under normal condition.

The edge damage was judged visually and was scored as follows:

xxxxx: very bad damage and not acceptable

xxxx: bad damage and not acceptable

xxx: moderate damage and just acceptable

xx: good; small damage

x: very good, almost no damage

Table 1 gives the composition of the base papers and the result of edge damage after applying a resin-coating on top- and back side of the pigment and non-pigmented coated paper base and coating photosensitive layers on top-side and processing them on the Frontier™ 350.

Comparative Example 29 gave good result on edge damage, however Example 29 is manufactured with a non-pigment coated paper and does not show an acceptable behavior with respect to smoothness and gloss.

TABLE 1

| | Example | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| | I^{#} | I^{#} | I^{#} | I^{#} | I^{#} | I^{#} | I^{#} | I^{#} | I^{#} | I^{#} | I^{#} | I^{#} | I^{#} | I^{#} | I^{#} |
| AKD (wt %) | 0.6 | 0.6 | 0.6 | 0.6 | 0.6 | 0.6 | 0.6 | 0.6 | 0.6 | 0.6 | 0.6 | 0.6 | 0.6 | 0.6 | 0.6 |
| EFA (wt %) | | | | | | | | | | | | | | | |
| PEA (wt %) | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| wet end | | | | | | | | | | | | | | | |
| chemical | | | | | | | | | | | | | | | |
| PEA (g/m²) | | | | | | | | | | | | | | | |
| surface | | | | | | | | | | | | | | | |
| size | | | | | | | | | | | | | | | |
| Pigment | 100 | 100 | 100 | 100 | 100 | 100 | 100 | 100 | 100 | 100 | 100 | 100 | 100 | 100 | 100 |
| (parts) | | | | | | | | | | | | | | | |
| Binder latex | | | | | | | 15 | 15 | 25 | 35 | 45 | 55 | 25 | 25 | 25 |
| (parts) | | | | | | | | | | | | | | | |
| Binder | 15 | 15 | 25 | 35 | 45 | 55 | 3 | 3 | 3 | 3 | 3 | 3 | 3 | 3 | 3 |
| starch | | | | | | | | | | | | | | | |
| (parts) | | | | | | | | | | | | | | | |
| Binder | | | | | | | | | | | | | | | |
| PVOH | | | | | | | | | | | | | | | |
| (parts) | | | | | | | | | | | | | | | |
| Total binder | 15 | 15 | 25 | 35 | 45 | 55 | 18 | 18 | 28 | 38 | 48 | 58 | 28 | 28 | 28 |
| (parts) | | | | | | | | | | | | | | | |
| Insolubilizer | 0.8 | 1.5 | 1.3 | 1.8 | 2.3 | 2.8 | 0.9 | 1.8 | 1.4 | 1.9 | 2.4 | 2.9 | | | |
| 1 (parts) | | | | | | | | | | | | | | | |
| Insolubilizer | | | | | | | | | | | | | 0.1 | 0.3 | 2 |
| 2 (parts) | | | | | | | | | | | | | | | |
| Insolubilizer | 5 | 10 | 5 | 5 | 5 | 5 | 5 | 10 | 5 | 5 | 5 | 5 | 0.4 | 1.0 | 7.5 |
| (wt % vs dry | | | | | | | | | | | | | | | |
| binder) | | | | | | | | | | | | | | | |
| Pigment | Yes | Yes | Yes | Yes | Yes | Yes | Yes | Yes | Yes | Yes | Yes | Yes | Yes | Yes | Yes |
| coated | | | | | | | | | | | | | | | |
| Scratches | xxx | xxx | xxx | xx | x | x | xx | xx | xx | x | x | x | xxx | xx | x |
| Edge | xxx | xx | xx | xx | x | x | xxx | xx | xx | xx | x | x | xx | xx | x |
| damage^{a} | | | | | | | | | | | | | | | |

| | Example | | | | | | | | | | | | | |
|---|---|---|---|---|---|---|---|---|---|---|---|---|---|---|
| | 16 | 17 | 18 | 19 | 20 | 21 | 22 | 23 | 24 | 25 | 26 | 27 | 28 | 29 |
| | I^{#} | I^{#} | I^{#} | C^{@} | C^{@} | C^{@} | C^{@} | C^{@} | C^{@} | C^{@} | C^{@} | C^{@} | C^{@} | C^{@} |
| AKD (wt %) | 0.6 | 0.4 | 0.4 | 0.6 | 0.6 | 0.6 | 0.6 | 0.6 | 0.6 | 0.6 | 0.6 | 0.6 | 0.4 | 0.6 |
| EFA (wt %) | | 0.2 | 0.2 | | | | | | | | | | 0.2 | |
| PEA (wt %) | 0.5 | 0.5 | | | 0.5 | | 0.5 | 0.5 | 0.5 | | 0.5 | 0.5 | | 0.5 |
| wet end | | | | | | | | | | | | | | |
| chemical | | | | | | | | | | | | | | |
| PEA (g/m²) | | | 0.5 | | | | | | | | | | 0.5 | |
| surface | | | | | | | | | | | | | | |
| size | | | | | | | | | | | | | | |
| Pigment | 100 | 100 | 100 | 100 | 100 | 100 | 100 | 100 | 100 | 100 | 100 | 100 | 100 | 100 |
| (parts) | | | | | | | | | | | | | | |
| Binder latex | 25 | 25 | 25 | | | | | | 15 | 15 | 45 | 55 | 25 | |
| (parts) | | | | | | | | | | | | | | |
| Binder | 3 | | 3 | 15 | 15 | 15 | 45 | 55 | 3 | 3 | 3 | 3 | 3 | |
| starch | | | | | | | | | | | | | | |
| (parts) | | | | | | | | | | | | | | |
| Binder | | 3 | | | | | | | | | | | | |
| PVOH | | | | | | | | | | | | | | |
| (parts) | | | | | | | | | | | | | | |
| Total binder | 28 | 28 | 28 | 15 | 15 | 15 | 45 | 55 | 18 | 18 | 48 | 58 | 28 | |
| (parts) | | | | | | | | | | | | | | |
| Insolubilizer | | 1.4 | 1.4 | | | 1.5 | | | | 1.8 | | | | |
| 1 (parts) | | | | | | | | | | | | | | |
| Insolubilizer | 8 | | | | | | | | | | | | | |
| 2 (parts) | | | | | | | | | | | | | | |
| Insolubilizer | 30 | 5 | 5 | 0 | 0 | 10 | 0 | 0 | 0 | 10 | 0 | 0 | 0 | 0 |
| (wt % vs dry | | | | | | | | | | | | | | |
| binder) | | | | | | | | | | | | | | |
| Pigment | Yes | Yes | Yes | Yes | Yes | Yes | Yes | Yes | Yes | Yes | Yes | Yes | Yes | No |
| coated | | | | | | | | | | | | | | |
| Scratches | x | xx | xx | xxxx | xxx | xxxx | xxx | xxx | xxxx | xxx | xxx | xxx | xxx | x |
| Edge | x | xx | xx | xxxxx | xxxx | xxxx | xxx | xxx | xxxx | xxxx | xxx | xxx | xxxx | x |
| damage^{a} | | | | | | | | | | | | | | |

^{#}Inventive examples;
^{@}Comparative examples
^{a}after first melt co-extrusion coating at the top- and back side and then coating photographical emulsions on topside of the melt co-extrusion samples according to experiment 2

1. A pigment coated paper base comprising a paper base having a topside and a backside, which paper base comprises one or more wet strength agents, and a pigment coating on at least the topside of said paper base, which pigment coating comprises one or more insolubilizers.

2. The pigment coated paper base according to claim 1, wherein said wet strength agent is present in an amount of 0.1 to 2.0 wt. % based on the dry pulp weight of the paper base.

3. The pigment coated paper base according to claim 1, wherein said wet strength agent is selected from the group consisting of epoxidized polyamide resins, zirconium based compounds, melamine-formaldehyde resins, urea-formaldehyde resins, dialdehyde starch, glyoxal, glyoxalated polyacrylamide (PAM), polyethylenimine (PEI) resins, and combinations thereof.

4. The pigment coated paper base according to claim 3, wherein said epoxidized polyamide resin is a poly(amido-amine)-epichlorohydrin (PAE) resin.

5. The pigment coated paper base according to claim 1, wherein said paper base comprises one or more agents selected from alkyl ketene dimers (AKD), epoxidized fatty acid amides (EFA) and combinations thereof.

6. The pigment coated paper base according to claim 5 comprising EFA and AKD in a EFA/AKD weight ratio of 10/90 to 60/40.

7. The pigment coated paper base according to claim 5, wherein the EFA is selected from the group consisting of: condensation products of stearic acid, oleic acid, lauric acid, palmitic acid, arachic acid, behenic acid, tall oil fatty acid, alkylsuccinic acid, alkenyl succinic acid, polyamines, epichlorohydrin, and combinations thereof.

8. The pigment coated paper base according to claim 5, wherein the AKD comprises alkyl chains containing from 8 to 30 carbon atoms.

9. The pigment coated paper base according to claim 5, wherein the EFA is a condensation product comprising behenic acid and/or wherein the AKD is derived from behenic acid.

10. The pigment coated paper base according to claim 5, wherein the EFA is a condensation product comprising behenic acid, diethylenetriamine and/or triethylenetetramine, and epichlorohydrin.

11. The pigment coated paper base according to claim 1, having an average surface roughness R_{A} of less than 1.0 μm.

12. The pigment coated paper base according to claim 1, wherein the paper base is present in an amount of 50 to 300 g/m².

13. The pigment coated paper base according to claim 1, wherein said insolubilizer is selected from the group consisting of epoxidized polyamide resins, melamine-formaldehyde resins, urea-formaldehyde resins, dialdehyde starch, glyoxal, glyoxalated polyacrylamide (PAM), polyethylenimine (PEI) resins, and combinations thereof.

14. The pigment coated paper base according to claim 1, wherein said insolubilizer is selected from the group of polyglycidyllether or aziridine resins or zirconium based compounds.

15. The pigment coated paper base according to claim 1, wherein said insolubilizer is present in 0.1 to 30 wt. % versus the dry weight of the binder in said pigment coating.

16. The pigment coated paper base according to claim 1, wherein said insolubilizer is present in 3.0 to 20 wt. % versus the dry weight of the binder in said pigment coating.

17. The pigment coated paper base according to claim 1, wherein the pigment of said pigment coating is selected from the group consisting of CaCO₃, TiO₂, BaSO₄, clay, magnesium-aluminum silicate, styrene-acrylic copolymers and combinations thereof.

18. The pigment coated paper base according to claim 1, wherein the binder of said pigment coating is selected from the group consisting of styrene-acrylic latex, styrene-butadiene latex, methyl methacrylate-butadiene latex, polyacrylate latex, polyvinyl alcohol, polysaccharide, starch and combinations thereof.

19. The pigment coated paper base according to claim 1, wherein said pigment coating comprises a binder/pigment weight ratio of 10/100 to 40/100.

20. The pigment coated paper base according to claim 1, wherein the pigment coating is present in an amount of 0.5 to 40 g/m².

21. The pigment coated paper base according to claim 1, wherein furthermore a polymer resin layer is present on the backside of said pigment coated paper base.

22. A support comprising a pigment coated paper base according to claim 1, wherein a polymer resin layer is present on the topside of said pigment coated paper base.

23. The support according to claim 22, wherein furthermore a polymer resin layer is present on the backside of said pigment coated paper base.

24. The support according to claim 22, wherein said polymer resin layer that is present on topside of said pigment coated paper base comprises at least one further pigment.

25. The support according to claim 24, wherein said further pigment is selected from the group consisting of CaCO₃, TiO₂, BaSO₄, clay, magnesium-aluminum silicate and combinations thereof.

26. The support or pigment coated paper base according to claim 21, wherein said polymer resin layer on topside and/or backside of said pigment coated paper base is present in an amount of from 5 to 60 g/m².

27. The support or pigment coated paper base according to claim 21 having a thickness of from 60 to 360 micrometer.

28. The support or pigment coated paper base according to claim 21, in which said polymer resin is selected from the group consisting of a polyethylene resin, a polypropylene resin and a polymethyl-methacrylate resin and combinations thereof.

29. The support or pigment coated paper base according to claim 21, in which said polymer resin has been applied on the topside and/or on the backside using melt extrusion coating or melt co-extrusion coating with a speed of at least 200 m/min.

30. A process for producing a pigment coated paper base, comprising providing a paper base using one or more wet strength agents, having a topside and a backside and applying a pigment coating comprising at least one insolubilizer on at least the topside of said paper base.

31. A process according to claim 30, in which the pigment coated paper base is provided on the topside with a pigmented polymer resin applied through melt (co)-extrusion coating.

32. The process according to claim 30, in which the pigment coated paper base is provided on the backside with a polymer resin applied through melt (co)-extrusion coating.

33. The process according to claim 31, wherein the polymer resin coating is applied at a paper speed of at least 200 m/min.

34-39. (canceled)
